(19) United States
(12) Patent Application Publication
(10) Pub. No.: US 2010/0265320 A1
(43) Pub. Date: Oct. 21, 2010

(54) System and Method for Improved Forensic Analysis

(75) Inventors: Patrick Treado, Pittsburgh, PA (US); David Exline, Gibsonia, PA (US); Julianne Wolfe, Pittsburgh, PA (US)

Correspondence Address: CHEMIMAGE CORPORATION, 7301 PENN AVENUE, PITTSBURGH, PA, 15208, US

(73) Assignee: ChemImage Corporation, Pittsburgh, PA (US)

(21) Appl. No.: 12/765,188

(22) Filed: May 24, 2010

Related U.S. Application Data
(63) Continuation-in-part of application No. 12/243,683, filed on Oct. 1, 2008, now abandoned.
Application No. 12/243,683 is a continuation of application No. 10/698,243, filed on Oct. 31, 2003, now abandoned.
(60) Provisional application No. 60/422,604, filed on Oct. 31, 2002.

(51) Int. Cl. G06T 7/00; H04N 7/18

(52) U.S. Cl. 348/61; 382/100; 348/E07.085

(57) ABSTRACT

A system and method for analyzing a forensic sample. A forensic sample is illuminated nondestructively with light of a first wavelength λ₁. A first image of the forensic sample is imaged using light emitted at a second wavelength λ₂, the second wavelength filtered by a multi-conjugate tunable filter. A second image of the forensic sample is imaged using the light emitted from the sample at a third wavelength λ₃, different from λ₂, the third wavelength filtered by a multi-conjugate tunable filter. A calculated image of the forensic image is then created from the first image and the second image. The disclosure also provides for obtaining a processed image by applying a chemometric technique to the calculated image and for identifying the sample as a known forensic material by searching a reference database for a match to either the calculated image or the processed image.

### REFERENCE TO RELATED APPLICATIONS

This application is a continuation-in-part of U.S. patent application Ser. No. 12/243,683, entitled “Method for Improved Forensic Analysis,” filed on Oct. 1, 2008, which itself is a continuation of U.S. patent application Ser. No. 10/698,243, entitled “Method for Improved Forensic Analysis,” filed on Oct. 31, 2003, which itself claims priority pursuant to 35 U.S.C. §119(e) to U.S. Provisional Application No. 60/422,604, filed Oct. 31, 2002. All of these patents and applications are hereby incorporated by reference in their entireties.

### FIELD OF THE INVENTION

The present invention relates to the field of forensic analysis and, more specifically, to the use of multi-view digital imaging of forensic samples at multiple reflected, scattered, emitted, transmitted or absorbed wavelengths to provide new, detailed information to distinguish and differentiate forensic materials and samples. This method allows more subtle forensic features to be observed and related to the image of the sample or to known reference samples than previously possible.

### BACKGROUND OF THE INVENTION

Forensic analysis involves the observation and identification of an object that may exist in part or in its entirety on some sort of supporting surface. This analysis typically compares the sample in question to other possible reference samples or reference data to make an association that relates it to a specific person, place or event. Forensic analysis is widely used in law enforcement or legal disputes as evidence in a range of situations from homicide to fraud. More specifically, the goal is usually to provide evidence of the existence of a direct link, for example, between a suspect and a crime scene, a victim and a suspect, a weapon and a suspect, etc. To do so with a high degree of specificity and discrimination from possible variations of the sample is essential. Examples of forensic samples include, but are not limited to, fingerprints, gunshot residues, questioned documents, condom lubricants, multi-layer paint chips, fibers, ink samples and thin layer chromatography plates.

The quality of a forensic analysis is critical in making the association of evidence as unambiguous as possible, thereby providing compelling identifications and linkages. In many cases, such as with fingerprints, this identification has widely accepted requirements where as in others, such as fiber characterization and comparison, the uniqueness of the results can be disputed. Even the most unique and definitive identification of biological evidence based on genetic information has been successfully questioned and removed as compelling evidence. Minimizing the subjective components or features of a forensic analysis to make compelling identifications and linkages therefore becomes a critical aspect of all forensic analysis. Doing so quickly and in a cost effective manner is equally important.

Advances in science and technology have enabled many new approaches to sample analysis, bringing forensic science into an era which goes far beyond the classic perception of an investigator looking thru a magnifying glass for small traces of evidence. Numerous techniques exist that allow detailed chemical and elemental identification. This includes most all analytical chemistry methods, such as mass spectroscopy, x-ray analysis, scanning electron microscopy and chromatography, that are widely used today to characterize gaseous, liquid and solid materials. Many of these methods are extremely sensitive and require finite material for their use that is consumed as part of the analysis process. Advances in the sensitivity of analytical chemistry methods and instruments over the years have reduced this problem but these methods are still not considered non-destructive. This becomes increasingly important as smaller and smaller pieces of pieces of evidence are examined and required in forensic analysis.

Optical spectroscopy is a type of detection and analysis method that need not destroy a sample and that can often be chemically specific. Infrared (reflection or transmission) spectroscopy, Raman spectroscopy, light polarization spectroscopy and Fourier transform infrared spectroscopy all fall into this category. These techniques carry an advantage in that they can be applied in a non-destructive manner yet obtain rich, detailed information.

For both analytical chemistry approaches as well as the aforementioned optical methods, the analysis is performed on a small piece or a specific region of the sample that is selected for analysis and compared to another reference sample or samples. Essentially, these analysis methods take a measurement at a point or averages over a small region, which is considered to be representative of the sample. A comparison of different samples is done by taking the measured output from each by the analysis instrument and comparing them. The output for these comparisons is typically a detailed graph of the measured signal as a function of some technical variable, like mass, atomic weight or wavelength. These signals form a complicated line pattern or graph. These patterns or graphs can be rich in detailed features and clearly interpreted by scientific experts. However, the principles of such methods and the resulting graphs can be difficult for other non-experts to interpret or place confidence in. Thus, when presenting this evidence in courtrooms, such techniques may not be sufficiently understood to provide convincing or compelling evidence.

In most legal cases, the ability of a jury or judge to understand the forensic evidence and the ability of the scientist to convey its value determines the utility of the forensic method. As a result, methods which allow the objects to be visually compared or which show simple representations of the item under scrutiny are the most widely accepted and understood by non-specialists. Despite the existence of many advanced scientific techniques and analysis methods that are very sophisticated, many such techniques may not be understood by non-specialists, and may thereby raise some doubts as to its validity. Visual forensic analysis and visual comparisons are amongst the most widely accepted forensic methods used to date.

Because many forensic analyses generally focuses on visual inspections, advances in this field have focused on providing optimized illumination by using high intensity sources, as in U.S. Pat. No. 5,072,338 (Hug, et al., entitled “Inspection/Detection System With A Laser Module For Use In Forensic Applications”), or variable wavelength, as in U.S. Pat. No. 6,239,904 (Serfling, et al., entitled “Forensic Microscope, In Particular For Examination Of Writing”) as well as enhancing the response from the forensic sample by applying special dyes, as in U.S. Pat. No. 6,485,981 (Fernandez, entitled “Method And Apparatus For Imaging And Documenting Fingerprints”). In the latter case, these dyes allow the forensic material to be enhanced when viewed by certain incident illumination. All of these methods focus on the type and nature of the incident radiation, and, in many cases, to tuning the incident radiation wavelength to optimize the signal for visual inspection. Other forensic examination devices have also employed a particular non-variable wavelength filter to analyze the reflected or emitted light to enhance the contrast of the forensic image. The choice of the particular filter used in such analysis is determined by the particular sample being studied or the particular chemical treatments used by the forensic scientists to enhance features in the forensic sample, such a latent fingerprints.

One difficulty with systems of the prior art is their relative lack of dynamic range and resolution, making it difficult to clearly differentiate small, subtle or minute variations over the forensic sample. Prior art systems produce a single image at a given wavelength or set of wavelengths of emitted radiation, making it impossible to view or obtain data from minute portions or different regions of the overall sample if the emitted radiation varies slightly within the sample or compared to the background substrate or sample matrix.

### SUMMARY OF THE INVENTION

The apparatus and method of forensic analysis of the present invention focuses on creating multiple views of the sample using the emitted, scattered, reflected or absorbed radiation over a wide range of wavelengths in one continuous measurement. Additionally, for each pixel at any given resolution, data representing the intensity of light collected by an image sensor is stored for each wavelength at which a view is collected. These views, at different wavelengths coming off of the sample, form the basis for differentiating the features of a sample that is not possible with a single image snapshot, such as is provided by prior art systems. In some cases, this also involves selecting a particular wavelength or range of wavelengths of incident radiation so that the samples are most likely to respond, for example, the near infrared, ultraviolet, or visible regions. Certain types of samples, for example, fibers or fingerprints, are known by those of ordinary skill in the art to show enhanced reflection, emission or luminescence at particular incident wavelengths, which forms the basis for the selection of a particular incident wavelength for illumination.

In the multi-view approach of the present invention, the reflection, absorption, emission or scattering of this incident illumination at a plurality of wavelengths over the entire image of the forensic specimen is examined to create multiple views of the specimen. No tuning of the incident radiation is required to perform this analysis. The multiple views are captured digitally and computer processed to show how the forensic material signals vary at any point (pixel) in the sample over the entire filed of view. These chemical spatial variations can then be processed with a computer to be identified and mapped onto the original image, thereby providing additional clarity over the single snapshot image.

The method of the present invention uses a particular process of wavelength selection and advanced digital image processing to further differentiate and enhance the various features in the forensic sample. These differences represent variations that can exist in the forensic samples themselves, and thereby often require no additional additives or treatment of the samples, unlike conventional methods, which, in many cases, require special processing or treatment to be defined or seen. Further, by differentiating the multi-view image variations and relating these variations to possible references or source samples, we need not identify the specific elements or specific chemicals involved. This simplifies and distinguishes this approach from those that employ chemical analytic techniques, which identify elements, chemicals or compositions.

### BRIEF DESCRIPTION OF THE DRAWINGS

The accompanying drawings, which are included to provide further understanding of the disclosure and are incorporated in and constitute a part of this specification, illustrate embodiments of the disclosure, and together with the description, serve to explain the principles of the disclosure.

In the drawings:

FIG. 1 is a schematic representation of a typical prior art forensic scope.

FIG. 2 is a schematic representation of an embodiment of a multi-view forensic scope of the present invention.

FIG. 3 is a schematic representation of examples of multi-views at three different observation wavelengths with the same pixel location selected in each field of view for each multi-view image in this set of multi-view images.

FIG. 4 illustrates a series of computer processed intermediate graphical representations of the pixel intensities for each view (observation wavelength) for the five selected pixels indicated in FIG. 3.

FIG. 5 is a representation of final computer generated multi-view image identifying the different regions of the forensic material in the image for two cases showing two (A) and three (B) distinct components spatially located as indicated. The dashed lines indicate the boundaries between these regions.

FIG. 6 is illustrative of a method of the present disclosure.

FIG. 7 is illustrative of a method of the present disclosure.

FIG. 8 is representative of a comparison of obliteration raw data using bother MCF and LCTF technology.

FIG. 9 is representative of a comparison of obliteration processed data.

FIG. 10 illustrates spectra of blue ink obtained using MCF and LCTF technology.

FIG. 11 is representative of a comparison of obliteration data processed using PCA.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

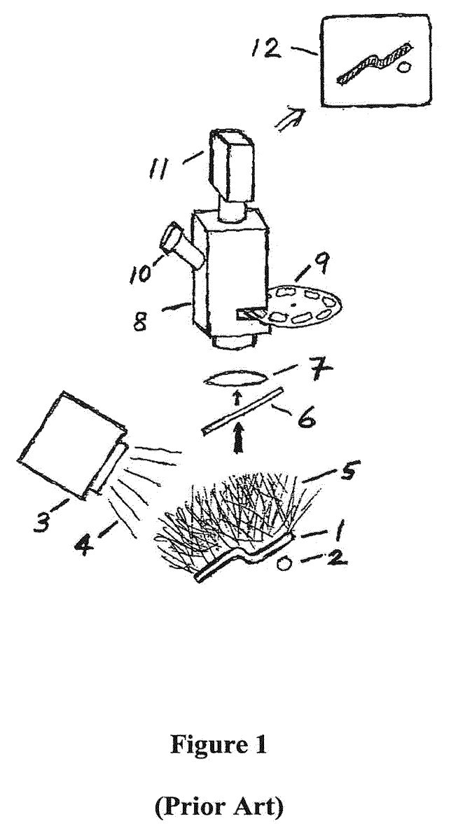

FIG. 1 shows a general schematic of a typical prior art forensic analysis system. The specimen 1, and reference sample 2, nearby specimen 1 are illuminated with radiation 4 by light source 3, which produces radiation 5, which is reflected from or emitted by specimen 1, and reference sample 2. Light source 3 may or may not be tunable to enhance or accentuate certain features as viewed through the scope or on the sample itself. Usually, the background near the specimen or a calibration object serves as the reference for many measurements. Reflected or emitted radiation 5 may be treated by a conditioning filter 6, and focused via a lens 7, into an optical housing 8, for image capture. In many cases, conditioning filter 6, or filter wheel 9, is used to select a specific wavelength of the light from the sample to obtain a single image at the desired wavelength. Filter wheel 9 is used to accommodate a range of different filters, where each filter is designed and known by those skilled in the art to view different types of samples, for example, one filter for certain fibers, another filter for latent fingerprints, etc. Optical housing 8 typically forms the main body of the forensic platform and interfaces the unit to one or more viewing eyepieces 10, and other image capture devices 11, such as a film, digital camera or video camera.

The prior art systems are designed to produce a single snapshot, video picture or digital image 12, of the forensic sample that documents what the image of the forensic sample looks like at the incident wavelength. This is then visually compared to other reference samples taken under the same instrument conditions.

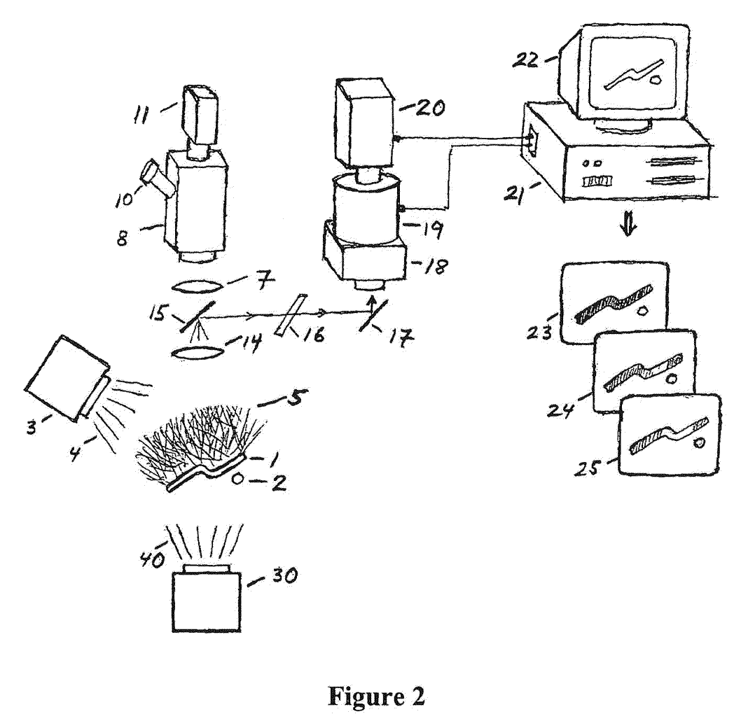

FIG. 2 shows a schematic of one embodiment of a multi-view forensic scope of the present invention. The scope of the present invention consists of multi-view optical train 18, electronic view selector 19 and image sensor 20. Multi-view optical train 18 accepts the sample light and matches its spatial characteristics to electronic view selector 19, the output of which is captured by image sensor, 20. Mirrors 15 and 17 direct radiation which is emitted, scattered, absorbed or reflected from specimen 1 into the multi-view scope. An optional intermediate filter 16 can be used to filter out certain undesirable components from the scattered, emitted or radiated radiation to optimize the performance of the multi-view optical train 18. Computer 21 controls electronic view sensor 19 and collects data from image sensor 20 for storage and processing. Images of the processed data are rendered on display 22. The multi-view scope configuration shown in FIG. 2 allows for sample viewing with a conventional forensic scope with a movable mirror 15 inserted to deflect the radiation 5 from the sample 1 into the multi-view optical train, electronic view selector and image sensor. An optional configuration would directly accept the sample radiation, 5, into the multi-view optical train 18, electronic view selector 19 and image sensor 20 thru a focusing lens similar to 14 and a conditioning filter 16 directly between the sample 1 and the multi-view optical train 18.

Images 23, 24 and 25 in FIG. 2 represent views of specimen 1 at varying wavelengths of emitted, scattered, absorbed or reflected radiation 5. Specimen 1 and reference 2, are illuminated by radiation 4 emitted by a light source 3, which, unlike many forensic scopes, need not be tunable due to the use of electronic view selector 19. In general the light source used for the multi-view scope can cover a larger range, approximately 200 nm to 2000 nm, than a conventional forensic scope. For forensic analysis using transmitted light, a different orientation of the light source 30, and illumination 40, are used. Emitted, scattered, absorbed, reflected, or radiated light 5 from specimen 1 and reference 2 is collected and focused via light gathering optics 14.

In general, the sample size determines the choice of light gathering optics 14. For example, a microscope lens will be employed for the analysis of sub-micron to millimeter dimension specimens. For larger objects in the range of millimeters to meter dimensions, macro lens optics are appropriate.

Electronic view selector 19 can be an electro-optical tunable filter such as a liquid crystal tunable filter (LCTF) or an acousto-optical tunable filter (AOTF). In another embodiment, the tunable filter may comprise a multi-conjugate tunable filter (MCF). The multi-conjugate tunable filter technology may be that available from ChemImage Corporation, Pittsburgh, Pa. This technology is more fully described in U.S. Pat. No. 6,992,809 entitled “Multi-Conjugate Liquid Crystal Tunable Filter,” filed on Feb. 2, 2005, and U.S. Pat. No. 7,362,489, also entitled “Multi-Conjugate Liquid Crystal Tunable Filter, filed on Apr. 22, 2005. These patents are hereby incorporated by reference in their entireties. MCF technology holds valuable potential for systems and methods of forensic analysis. MCF technology has many potential advantages including temperature compensation and higher throughput that may aid in providing more useful, accurate, and reliable information.

These filters allow specific wavelengths or ranges of wavelengths of light to pass through as an image, depending on the electrical control voltages placed on the device by computer 22. The bandwidth or range of the wavelengths passed by this device can be as small as 0.1 nm or as large as 20 nm or greater. The choice of which device to use depends on the optical region used and/or the nature of the sample being analyzed. The wavelengths that can be passed through electronic view selector 19 range from 200 nm (i.e., the ultraviolet) to 2000 nm (i.e., the far infrared). In some instances, multiple electronic tunable filters may be used to cover the entire range of desired wavelengths.

In another embodiment, a system and method for extending this range may be implemented. Such a system and method are more fully described in U.S. Pat. No. 7,420,679 entitled, “Method and Apparatus for Extended Hyperspectral Imaging,” filed on Sep. 2, 2008, which is hereby incorporated by reference in its entirety.

Image sensor 20 is a digital device, typically a two-dimensional, imaging focal plane array (FPA). The optical region employed to characterize the sample of interest governs the choice of FPA detector. For example, silicon charge coupled device (CCD) detectors, a type of FPA, are employed with visible wavelength fluorescence and Raman spectroscopies, while gallium arsenide (GaAs) FPA detectors are typically employed for image analysis at near infrared wavelengths. The choice of these detectors depends on the type of forensic analysis desired. The imaging sensor produces digital images of the entire view of the forensic sample as processed by electronic view selector 19.

Both electronic view selector 19 and image sensor 20 are controlled and read by a computer 21, preferably a personal computer (PC), and displayed on display 22. A few schematic examples of the multi-view images obtained at different viewing wavelengths are shown as 23, 24 and 25. In most cases, the changes are smaller than those portrayed in this example, which is intended only as a schematic exemplar. Computer 22 and display 21 allows the user to interface, control, process and view the multi-view information from the forensic specimen 1 under investigation.

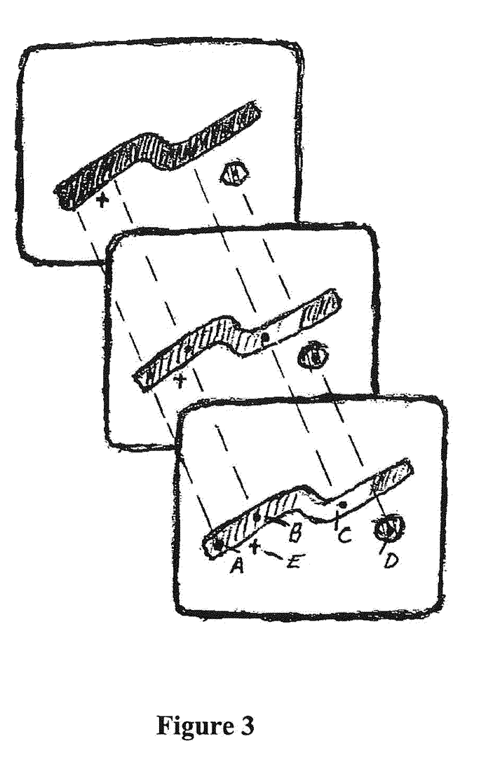

The computer processing of the multi-view information consists of converting the multi-view images into graphical representations of the intensity versus collected wavelength from any part, region or individual pixel element of the forensic sample, so as to determine the multi-view characteristics of these elements of the forensic sample. Typically all pixel elements in a picture are acquired and analyzed at one time, because, in many cases, it is not known which region or pixels in the field of view will turn out to be the most important or useful. As an example, FIG. 3 indicates five pixels, A, B, C, D and E being analyzed that correspond to the same location in each of the multi-view images. Pixels A, B and C correspond to pixels on the forensic specimen 1; pixel D corresponds to some reference object 2 in the field of view; and pixel E corresponds to a location nearby the sample, referred to as the background. These pixel sizes can range from submicron to millimeters dimensions depending on the magnification, sample and illumination used. In terms of resolution, a typical CCD used as image sensor 20 may have a resolution of 1024×1024 pixels, for a total of 1,048,576 pixels for each wavelength at which a view is captured. In typical operation, a range of wavelengths will be captured at predetermined increments, based on prior art knowledge of the specimen and the type of discrimination needed for the particular forensic analysis.

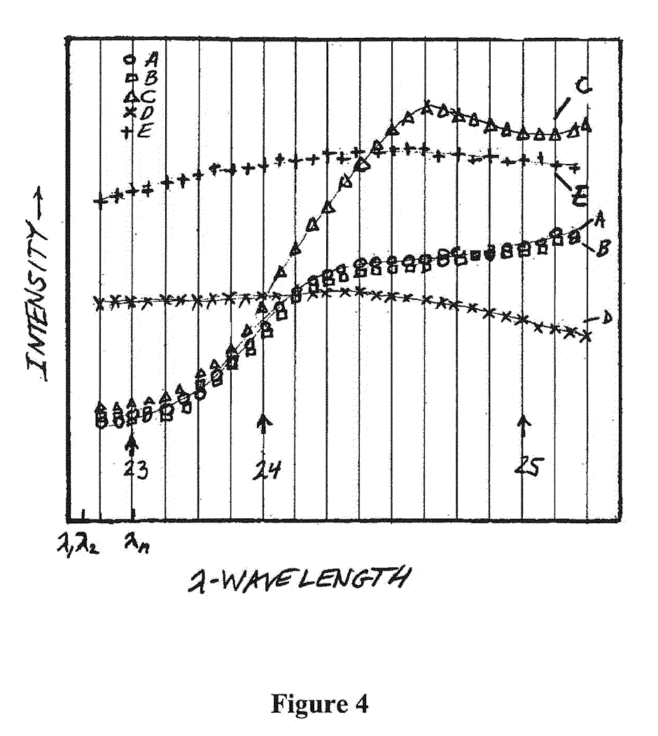

As shown in FIG. 4, computer 22 creates a graph of the intensities of pixels A-E as a function of the wavelengths of the emitted, scattered, transmitted or reflected light which were captured by image sensor 22. Such graphs occur for each of the million plus pixels in the image and become part of the detailed analysis and comparisons done by computer 22 to identify and tag similar or different multi-view characteristics of these pixels. Such data will typically show more scatter or noise than illustrated in FIG. 4, which can be accounted for by the computer in the identification of the differences in the multi-view variations. Use of the background variations as a reference signal also becomes particularly important to enhance or resolve subtle variations or differences in forensic samples that arise on a surface, such as a fingerprint. In many cases, computer 22 can rapidly search a database to find similar multi-view patterns to identify equivalent or related objects.

These intensity graphs of each pixel of the multi-view image are analyzed to define the variations in the emitted, reflected, transmitted or scattered light at every single pixel. All three pixels A, B, and C on specimen 1 have similar characteristic variations up to multi-view 24, which is a view at a particular wavelength (not specified), and at higher wavelengths only pixels A and B show similar characteristics. All are clearly distinguished in this example from the background sample E or reference sample D, which need not generally be the case. The computer processing of all pixels in this set of multi-view images would tag these pixels as well as identify those to known objects.

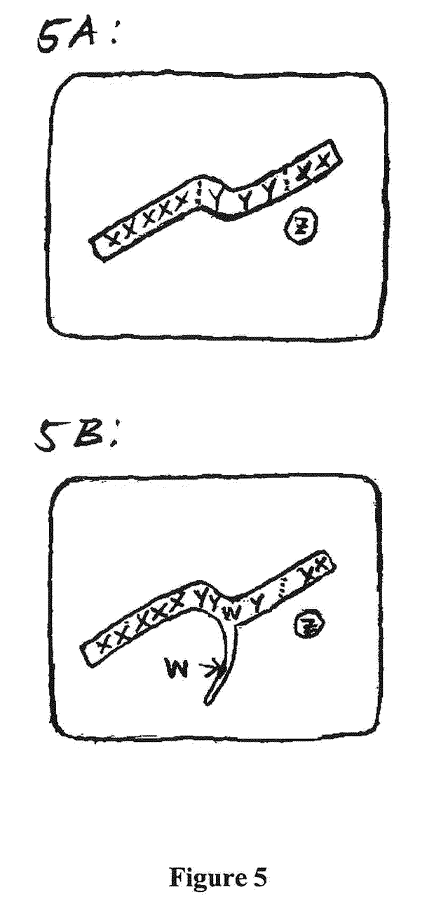

FIG. 5A shows a schematic representation of the final result of a multi-view analysis of the forensic sample discussed in FIGS. 3 and 4. Here, pixels in the central area of the sample show the multi-view features of pixel C of FIG. 3, and the area labeled as ‘Y’ in FIG. 5A. The other areas of the sample representative of pixels A and B of FIG. 3 are indicated as ‘X’ in FIG. 5A. These different multi-view characteristics may be associated with the variability of environmental, history and/or manufacturing influences, which becomes critical to the forensic analysis.

As an alternative to a graphical representation of each pixel, a more desirable mode of presenting these multi-view results is to color code similar pixels and overlay them onto the original image to visually distinguish these differences. In some cases, such as in two component systems, the multi-view image can be in black and white and will appear as a sharper more distinct, clearly defined image of the original sample, because more information has been detected and processed with the multi-view approach.

In more complicated cases schematically shown in FIG. 5B, a weak additional feature, labeled as W, may be observed that indicates yet another material not detected in the original forensic snapshot. Reference samples may further help to identify the nature or possible origin of this material. To aid in a more detailed evaluations, multi-view analysis using Raman scattering is possible, which generally provides richer multi-view features than shown in FIG. 4.

This invention collects and utilizes high definition digital images processed by an electronically controlled view selector 19 over a wide range of wavelengths of scattered, emitted, or reflected light from a forensic specimen 1 so as to provide multiple views of the specimen that are computer processed to differentiate minute features. Prior art forensic scopes do not allow nor facilitate such a capability. Other commercially available analytical instrumentation used to analyze the continuum of scattered or reflected light in detail as done with this device are typically performed in a point or line scanning mode, which is more time consuming and has limited spatial resolution due to the size of the spot probes used. These spot focused methods also concentrate the incident radiation and are thereby more likely to damage the sample. These instruments are typically analytical chemistry instruments that are not optimized for forensic applications.

The way the intensity of the forensic specimen or portions of the specimen vary from view to view creates a signature of the type or origin of the sample. Such multi-view signatures are very distinct and depend in many cases on subtle intrinsic properties of the sample, including its history or method of manufacture, which is not generally discernable using the single view snapshot method of forensic analysis widely used today. Such multi-view capability allows this invention to work even with difficult backgrounds, for example, fluorescent substrates, dark substrates, rough substrates and multicolored substrates.

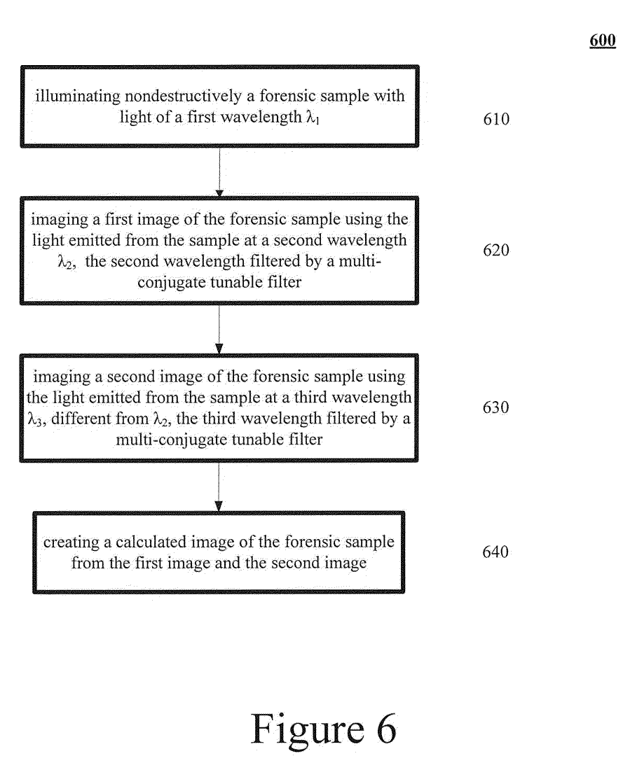

In one embodiment, the present disclosure provides for a method of creating a calculated image of a forensic sample. One embodiment of the method is illustrated in FIG. 6. The method 600 may comprise illuminating, in step 610, nondestructively a forensic sample with light of a first wavelength λ₁. In step 620, a first image of the forensic sample is imaged using the light emitted from the sample at a second wavelength λ₂, the second wavelength filtered by a multi-conjugate tunable filter. In step 630, a second image of the forensic sample is imaged using the light emitted from the sample at a third wavelength λ₃, different from λ₂, the third wavelength filtered by a multi-conjugate tunable filter. A calculated image of the forensic sample from the first image and the second image is created in step 640.

In one embodiment, the method may further comprise providing a reference database comprising a plurality of reference data sets. In one embodiment, each reference data set comprises at least one image representative of a known forensic material. This reference database can be searched to thereby identify a reference data set therein that matches said calculated image to thereby classify the sample as a known forensic material. It is also contemplated by the present disclosure that this reference database may comprise additional reference data sets corresponding to additional optical information including spectra corresponding to known forensic materials.

In one embodiment, the image may comprise an image selected from the group consisting of a Raman image, an infrared image, a near infrared image, a short wave infrared image, a mid infrared image, a fluorescence image, an ultraviolet image, a visible image, and combinations thereof. In another embodiment, the image may be a spatially accurate wavelength resolved image wherein said spatially accurate wavelength resolved image is an image selected from the group consisting of: a spatially accurate wavelength resolved Raman image, a spatially accurate wavelength resolved infrared image, a spatially accurate wavelength resolved near infrared image, a spatially accurate wavelength resolved short wave infrared image, a spatially accurate wavelength resolved mid infrared image, a spatially accurate wavelength resolved fluorescence image, a spatially accurate wavelength resolved ultraviolet image, a spatially accurate wavelength resolved visible image, and combinations thereof.

In another embodiment, the method may further comprise applying a chemometric technique to said calculated image. Such chemometric technique may be any known in the art including, but not limited to, one selected from the group consisting of: principal component analysis (PCA), Partial Least Squares Discriminate Analysis (PLSDA), Cosine Correlation Analysis (CCA), Euclidian Distance Analysis (EDA), k-means clustering, multivariate curve resolution (MCR), Band T. Entropy Method (BTEM), k means clustering, Mahalanobis Distance (MD), Adaptive Subspace Detector (ASD), Spectral Mixture Resolution, and combinations thereof.

In another embodiment, the method may further comprise correcting the calculated image using signals extracted from at least one of the first and second images, wherein the signal is extracted from a subset of pixels from at least one of the first and second image pixels. In one embodiment, the subset of at least one of the first and second image pixels is a subset chosen outside an area of interest of the at least one of the first and second images. In another embodiment, the correcting of the calculated image comprises subtracting a background signal provided by light of a wavelength λ from outside an area of interest from the image formed by light of wavelength λ₃ and λ₂ where λ is λ₃ or λ₂ or another wavelength.

The area of interest may comprise an area containing at least one of a suspected fingerprint, ink, suspected gunshot residue, suspected condom residue, a multi-layer paint chip, a fiber, a thin layer chromatography plate, and combinations thereof.

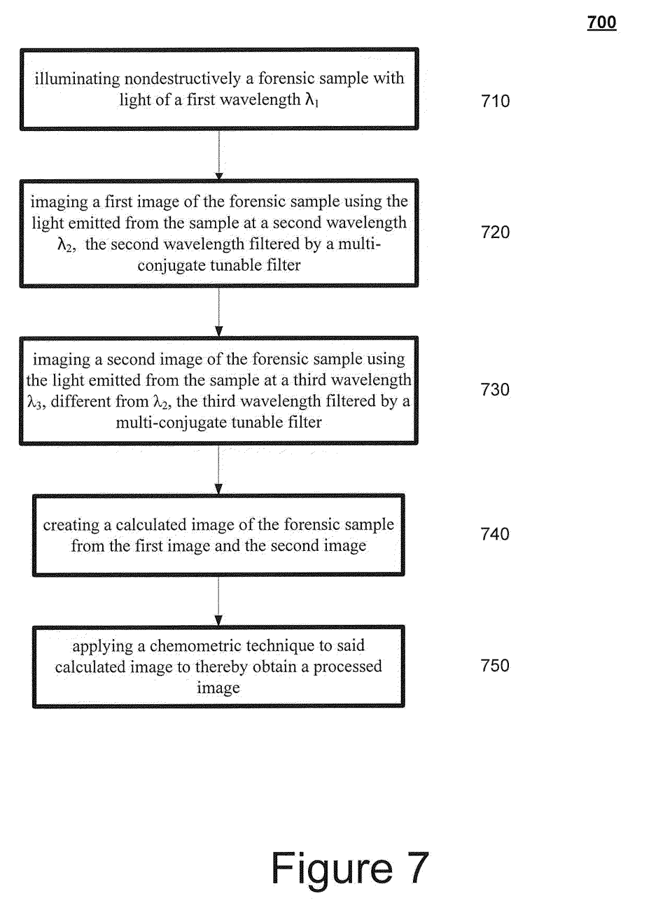

The present disclosure also provides for a method illustrated by FIG. 7. In such an embodiment, the method 700 provides for illuminating nondestructively a forensic sample with light of a first wavelength λ₁ in step 710. The forensic sample may be a sample selected from the group consisting of: an object carrying a suspected fingerprint, an object carrying ink, an object carrying suspected gunshot residue, an object carrying a suspected condom lubricant, a multilayer paint chip, a fiber, a thin layer chromatography plate, and combinations thereof. In step 720 a first image of the forensic sample is imaged using the light emitted from the sample at a second wavelength λ₂, the second wavelength filtered by a multi-conjugate tunable filter. Step 730 provides for imaging a second image of the forensic sample using the light emitted from the sample at a third wavelength λ₃, different from λ₂, the third wavelength filtered by a multi-conjugate tunable filter. A calculated image of the forensic sample is obtained in step 740 from the first image and the second image. In step 750 a chemometric technique is applied to the calculated image to thereby obtain a processed image.

In one embodiment, the chemometric technique may be any known in the art including but not limited to a technique selected from a group consisting of principal component analysis (PCA), Partial Least Squares Discriminate Analysis (PLSDA), Cosine Correlation Analysis (CCA), Euclidian Distance Analysis (EDA), k-means clustering, multivariate curve resolution (MCR), Band T. Entropy Method (BTEM), k means clustering, Mahalanobis Distance (MD), Adaptive Subspace Detector (ASD), Spectral Mixture Resolution, and combinations thereof.

In one embodiment, the method may further comprise providing a reference database comprising a plurality of reference data sets wherein each reference data set comprises at least one image representative of a known forensic material; searching said reference database to thereby identify a reference data set therein that matches said processed image to thereby classify the sample as a known forensic material.

In one embodiment, the image may be a spatially-accurate wavelength resolved image. In another embodiment the image may be an image selected from the group consisting of: a Raman image, an infrared image, a near infrared image, a short wave infrared image, a mid infrared image, a fluorescence image, an ultraviolet image, a visible image, and combinations thereof.

In another embodiment, the method may further comprise correcting the calculated image using signals extracted from at least one of the first and second images, wherein the signal is extracted from a subset of pixels from at least one of the first and second image pixels. In one embodiment, the subset of at least one of the first and second image pixels is a subset chosen outside an area of interest of the at least one of the first and second images. In another embodiment, the correcting of the calculated image comprises subtracting a background signal provided by light of a wavelength λ from outside an area of interest from the image formed by light of wavelength λ₃ and λ₂ where λ is λ₃ or λ₂ or another wavelength.

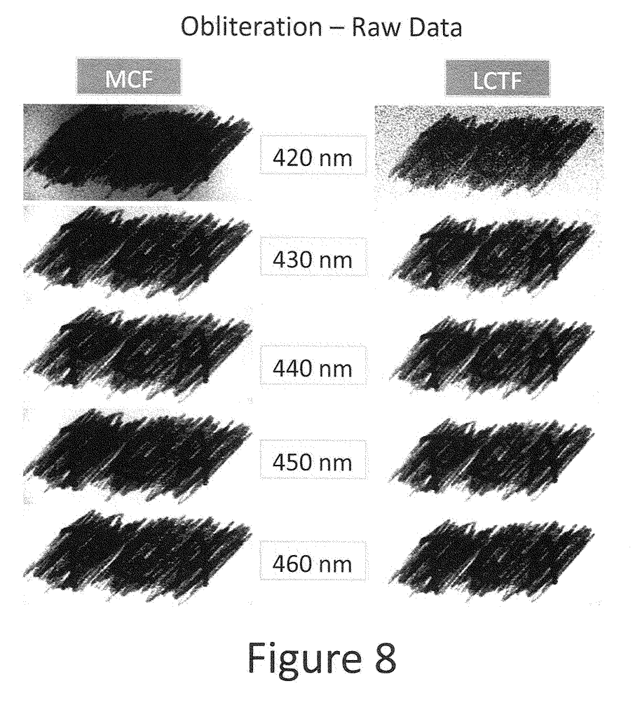

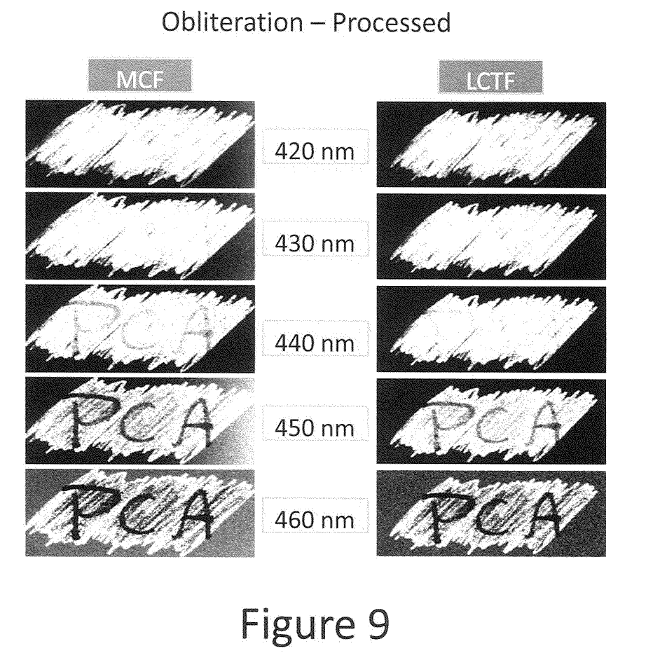

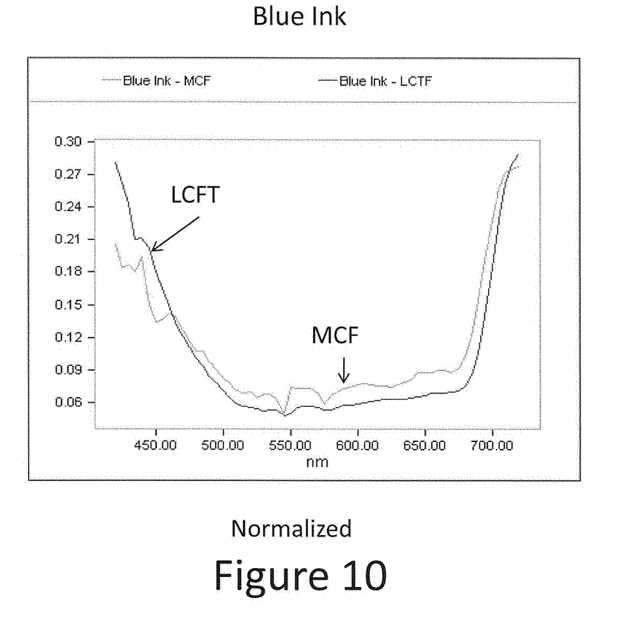

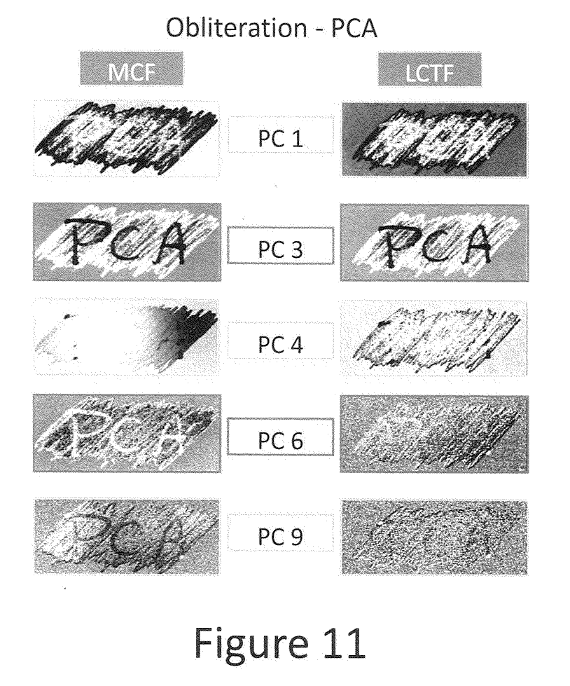

FIGS. 8-11 are provided to further illustrate the potential of MCF technology as applied to forensic samples. The figures illustrate red ink lettering on white paper background. The obliteration (scratch out) was accomplished using blue ink. FIG. 8 illustrates the analysis of ink samples using both MCF and LCTF technology. The potential advantages of using a MCF can be seen particularly when using 420 nm in the raw data. FIG. 9 illustrates the analysis of ink samples using both MCF and LCTF technology. The potential advantages of using a MCF can be seen particularly when using 430 nm, 440 nm, and 450 nm in the processed data. FIG. 10 illustrates the spectra of a blue ink sample using both MCF and LCTF technology. FIG. 11 illustrates the analysis of ink samples processed using PCA the potential advantages of using a MCF can be seen particularly when using PC6 and PC9.

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art, and may be made without departing from the spirit or scope of the disclosure.

What is claimed is:

1. A method comprising:
illuminating nondestructively a forensic sample with light of a first wavelength λ₁;
imaging a first image of the forensic sample using the light emitted from the sample at a second wavelength λ₂, the second wavelength filtered by a multi-conjugate tunable filter;
imaging a second image of the forensic sample using the light emitted from the sample at a third wavelength λ₃, different from λ₂, the third wavelength filtered by a multi-conjugate tunable filter; and
creating a calculated image of the forensic sample from the first image and the second image.

2. The method of claim 1 further comprising applying a chemometric technique to said calculated image to thereby obtain a processed image.

3. The method of claim 2 wherein said chemometric technique is selected from a group consisting of: principal component analysis (PCA), Partial Least Squares Discriminate Analysis (PLSDA), Cosine Correlation Analysis (CCA), Euclidian Distance Analysis (EDA), k-means clustering, multivariate curve resolution (MCR), Band T. Entropy Method (BTEM), k means clustering, Mahalanobis Distance (MD), Adaptive Subspace Detector (ASD), Spectral Mixture Resolution, and combinations thereof.

4. The method of claim 1 wherein said image is a spatially-accurate wavelength resolved image.

5. The method of claim 1 wherein said image is an image selected from the group consisting of: a Raman image, an infrared image, a near infrared image, a short wave infrared image, a mid infrared image, a fluorescence image, an ultraviolet image, a visible image, and combinations thereof.

6. The method of claim 1 further comprising correcting the calculated image using signals extracted from at least one of the first and second images, wherein said signal is extracted from a subset of pixels from at least one of the first and second image pixels.

7. The method of claim 6 wherein the subset of at least one of the first and second image pixels is a subset chosen outside an area of interest of the at least one of the first and second images.

8. The method of claim 7 wherein said area of interest comprises an area containing at least one of: a suspected fingerprint, ink, suspected gunshot residue, suspected condom residue, a multi-layer paint chip, a fiber, a thin layer chromatography plate, and combinations thereof.

9. The method of claim 7 wherein the correcting of the calculated image comprises subtracting a background signal provided by light of a wavelength λ from outside an area of interest from the image formed by light of wavelength λ₃ and λ₂ where λ is λ₃ or λ₂ or another wavelength.

10. The method of claim 1 wherein the forensic sample is selected from the group consisting of: an object carrying a suspected fingerprint, an object carrying ink, an object carrying suspected gunshot residue, an object carrying a suspected condom lubricant, a multilayer paint chip, a fiber, a thin layer chromatography plate, and combinations thereof.

11. The method of claim 1 further comprising:
providing a reference database comprising a plurality of reference data sets wherein each reference data set comprises at least one image representative of a known forensic material;
searching said reference database to thereby identify a reference data set therein that matches said calculated image to thereby classify the sample as a known forensic material.

12. A method comprising:
illuminating nondestructively a forensic sample with light of a first wavelength λ₁;
imaging a first image of the forensic sample using the light emitted from the sample at a second wavelength λ₂, the second wavelength filtered by a multi-conjugate tunable filter;
imaging a second image of the forensic sample using the light emitted from the sample at a third wavelength λ₃, different from λ₂, the third wavelength filtered by a multi-conjugate tunable filter;
creating a calculated image of the forensic sample from the first image and the second image;
applying a chemometric technique to said calculated image to thereby obtain a processed image.

13. The method of claim 12 further comprising:
providing a reference database comprising a plurality of reference data sets wherein each reference data set comprises at least one image representative of a known forensic material;
searching said reference database to thereby identify a reference data set therein that matches said processed image to thereby classify the sample as a known forensic material.

14. The method of claim 12 wherein said chemometric technique is selected from a group consisting of: principal component analysis (PCA), Partial Least Squares Discriminate Analysis (PLSDA), Cosine Correlation Analysis (CCA), Euclidian Distance Analysis (EDA), k-means clustering, multivariate curve resolution (MCR), Band T. Entropy Method (BTEM), k means clustering, Mahalanobis Distance (MD), Adaptive Subspace Detector (ASD), Spectral Mixture Resolution, and combinations thereof.

15. The method of claim 14 wherein said image is a spatially-accurate wavelength resolved image.

16. The method of claim 14 wherein said image is an image selected from the group consisting of: a Raman image, an infrared image, a near infrared image, a short wave infrared image, a mid infrared image, a fluorescence image, an ultraviolet image, a visible image, and combinations thereof.

17. The method of claim 14 further comprising correcting the calculated image using signals extracted from at least one of the first and second images, wherein said signal is extracted from a subset of pixels from at least one of the first and second image pixels.

18. The method of claim 17 wherein the subset of at least one of the first and second image pixels is a subset chosen outside an area of interest of the at least one of the first and second images.

19. The method of claim 18 wherein said area of interest comprises an area containing at least one of: a suspected fingerprint, ink, suspected gunshot residue, suspected condom residue, a multi-layer paint chip, a fiber, a thin layer chromatography plate, and combinations thereof.

20. The method of claim 18 wherein the correcting of the calculated image comprises subtracting a background signal provided by light of a wavelength λ from outside an area of interest from the image formed by light of wavelength λ₃ and λ₂ where λ is λ₃ or λ₂ or another wavelength.

21. The method of claim 14 wherein the forensic sample is selected from the group consisting of: an object carrying a suspected fingerprint, an object carrying ink, an object carrying suspected gunshot residue, an object carrying a suspected condom lubricant, a multilayer paint chip, a fiber, a thin layer chromatography plate, and combinations thereof.
